(19) United States
(12) Patent Application Publication
(10) Pub. No.: US 2025/0232408 A1
(43) Pub. Date: Jul. 17, 2025

(54) VIDEO COMPOSITING METHOD, COMPUTING DEVICE USING THE VIDEO COMPOSITING METHOD, AND SYSTEM INCLUDING THE COMPUTING DEVICE

(71) Applicant: Samsung Electronics Co., Ltd., Suwon-si (KR)

(72) Inventor: Kyungmin PARK, Suwon-si (KR)

(73) Assignee: Samsung Electronics Co., Ltd., Suwon-si (KR)

(21) Appl. No.: 18/930,090

(22) Filed: Oct. 29, 2024

(30) Foreign Application Priority Data
Jan. 16, 2024 (KR) 10-2024-0006757

(51) Int. Cl. G06T 5/50

(52) U.S. Cl. CPC G06T 5/50; G06T 2207/20221

(57) ABSTRACT

A computing device for compositing videos, the computing device including a first camera configured to capture a user video, and processing circuitry configured to, receive a background video, the receiving the background video including receiving the background video in real time, select a target object from the user video, generate a converted video based on the target object and the user video, generate a composited video based on the background video and the converted video, and output the composited video to a display device.

### CROSS-REFERENCE TO RELATED APPLICATION

This U.S. non-provisional application is based on and claims the benefit of priority under 35 U.S.C. § 119 to Korean Patent Application No. 10-2024-0006757, filed on Jan. 16, 2024, in the Korean Intellectual Property Office, the disclosure of which is incorporated by reference herein in its entirety.

### BACKGROUND

Various example embodiments of the inventive concepts relate to a method for compositing videos, and more particularly, to a method for compositing real time videos, a computing device using the method, a non-transitory computer readable medium storing computer readable instructions for performing the method, and/or a system including the computing device.

As electronic devices and communication technology have continued to develop, a digital culture in which many users create and watch videos has increased. In particular, the tendency of users to personally produce and share videos is increasing. Video compositing technology used for video production has been developed, however, this technology has many constraints, such as requiring separate devices and/or requiring additional tasks to make video production.

Thus, the desire and/or necessity of a technology for compositing and creating videos without any additional devices and/or additional tasks, in particular, a technology for easily compositing real time videos in a mobile terminal, is increasing.

### SUMMARY

One or more example embodiments of the inventive concepts provide a computing device in which a video and an object progressing in real time may be composited with each other, a system including the computing device, an operating method thereof, and/or a non-transitory computer readable medium storing computer readable instructions for performing the method, etc.

According to at least one example embodiments of the inventive concepts, there is provided a computing device for compositing videos, the computing device including a first camera configured to capture a user video, and processing circuitry configured to, receive a background video, the receiving the background video including receiving the background video in real time, select a target object from the user video, generate a converted video based on the target object and the user video, generate a composited video based on the background video and the converted video, and output the composited video to a display device.

According to at least one example embodiments of the inventive concepts, there is provided a method for composing videos, the method including capturing a user video using a first camera, receiving a real time background video, selecting a target object from the user video, generating a converted video based on the target object and the user video, generating a composited video in real time based on the received background video and the converted video, and outputting the composited video to a display device.

According to at least one example embodiments of the inventive concepts, there is provided a video compositing system including processing circuitry and memory connected to the processing circuitry and configured to store computer readable instructions, wherein the processing circuitry, by executing the computer readable instructions, is caused to, capture a user video using a first camera, receive a real time background video, select a target object from the user video, generate a converted video based on the target object and the user video, and generate a composited video in real time based on the background video and the converted video.

### BRIEF DESCRIPTION OF THE DRAWINGS

Various example embodiments will be more clearly understood from the following detailed description taken in conjunction with the accompanying drawings in which:

FIG. 1 is a block diagram illustrating a video compositing system according to at least one example embodiment;

FIG. 2 is a block diagram schematically illustrating a computing device according to at least one example embodiment;

FIG. 3 is a diagram illustrating an object selecting process according to at least one example embodiment;

FIG. 4 is a diagram illustrating video compositing according to at least one example embodiment;

FIG. 5 is a diagram illustrating receiving of a background video according to at least one example embodiment;

FIG. 6 is a block diagram illustrating a variety of background videos according to at least one example embodiment;

FIG. 7 is a diagram illustrating a background video according to at least one example embodiment;

FIG. 8 is a block diagram illustrating a communication process of transmitting a composited video according to at least one example embodiment;

FIG. 9 is a flowchart illustrating a video compositing method according to at least one example embodiment; and

FIG. 10 is a flowchart illustrating a process of receiving a background video according to at least one example embodiment.

### DETAILED DESCRIPTION

Hereinafter, various example embodiments of the inventive concepts will be described in detail with reference to the accompanying drawings.

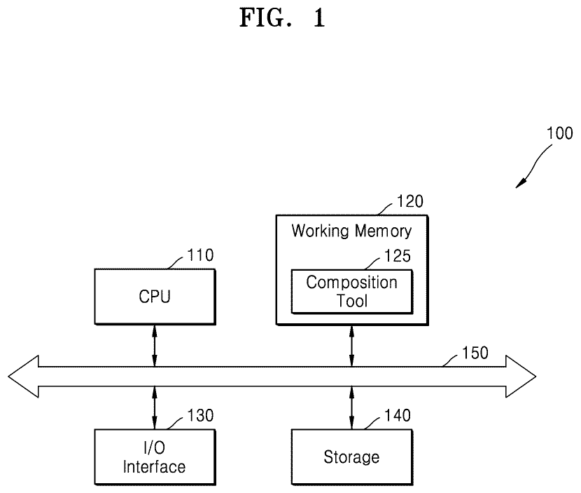

FIG. 1 is a block diagram illustrating a video compositing system according to at least one example embodiment.

Referring to FIG. 1, a video compositing system 100 may include a central processing unit (CPU) 110 (e.g., processing circuitry, etc.), for example, a processor, working memory (e.g., memory, memory device, etc.) 120, an I/O interface 130, a storage device 140, and/or a system bus 150, etc., but the example embodiments are not limited thereto, and for example, the video compositing system 100 may include a greater or lesser number of constituent components. The video compositing system 100 may be provided as a dedicated device for compositing various videos, but is not limited thereto, and for example may also be provided as a computer having various compositing tools installed thereon, etc.

The CPU 110 may execute software (e.g., a compositing tool 125, an application program, an operating system, a device driver, a module, etc.) to be performed in the video compositing system 100. For example, the CPU 110 may execute an operating system (OS) to be loaded on the working memory 120. The CPU 110 may execute various application programs and/or compositing tools to be driven and/or executed based on the operating system (OS). In some example embodiments, the CPU 110 may be configured to execute computer readable instructions for performing at least one of various operations of compositing videos. For example, a video compositing tool 125 provided as a compositing tool may be driven by the CPU 110. The video compositing tool 125 may refer to a special purpose program for performing a video compositing operation according to at least one example embodiment, the special purpose program including special purpose computer readable instructions for performing one or more operations of the methods discussed herein, etc. According to some example embodiments, one or more of the CPU 110, working memory 120, the I/O interface 130, and/or the system bus 150, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The operating system (OS) and/or application programs may be loaded on the working memory 120. When the video compositing system 100 is booted (e.g., boots up, powers on, etc.), an OS image stored in the storage device 140 may be loaded on the walking memory 120 based on a booting sequence. The OS may support all input and/or output operations of the video compositing system 100, but is not limited thereto. Similarly, application programs (e.g., the video compositing tool 125, etc.) that are selected by a user and/or provide basic services may be loaded on the working memory 120. The working memory 120 may be volatile memory, such as static random-access memory (SRAM) and/or dynamic random-access memory (DRAM), etc., and/or non-volatile memory, such as phase-change RAM (PRAM), magnetoresistive RAM(MRAM), resistive RAM(ReRAM), ferroelectric RAM(FRAM), flash memory, and/or the like.

In some example embodiments, the video compositing tool 125 may perform at least one compositing operation on one or more videos of the video compositing system 100, as will be described later. For example, the video compositing tool 125 may perform a compositing operation based on a background video and a user video, etc. In at least one example embodiment, the background video may be a video progressing (e.g., recording, playing, streaming, created, etc.) in real time and/or near real time, and the user video may be a video received through the I/O interface 130 of the video compositing system 100, but the example embodiments are not limited thereto.

In addition, in some example embodiments, the video compositing tool 125 may select at least one target object from the user video to generate a converted video. For example, the video compositing tool 125 may select at least one object (e.g., a target object) to be composited with (e.g., combined with, integrated with, etc.) the background video from the user video, and pixels of a video excluding the object may be processed transparently. In at least one example embodiment, the object may be an object selected by external control, etc. For example, the user may directly select an object to be composited with the background video from the user video, and may perform a converting operation based on the selected object, but the example embodiments are not limited thereto, and for example, the object selection may be performed by an automation, artificial intelligence, software programming, etc. In some example embodiments, the video compositing tool 125 may generate a converted video using a Chroma key method and/or by adjusting alpha values, but the example embodiments are not limited thereto.

The I/O interface 130 may control user input and/or output from user interface devices. For example, the I/O interface 130 may receive various data used in video compositing using a computing device by including at least one input device, such as a keyboard, a mouse, a camera, a microphone, and/or a touch pad, etc. In at least one example embodiment, the I/O interface 130 may receive a background video that is progressing (e.g., recording, playing, streaming, created, etc.) in real time (and/or near real time) from the outside (e.g., an external source, etc.), but the example embodiments are not limited thereto, and for example, the background video may be pre-recorded (e.g., a non-real time video, etc.). Additionally, and/or alternatively, a screen that is being executed on the computing device (e.g., video that is playing on a screen of the computing device, etc.) may be provided to the video compositing tool 125, etc. In some example embodiments, the I/O interface 130 may output (e.g., output to a display screen, etc.) the video composited by the video compositing tool 125 by including at least one output device, such as a monitor, a projector, a touchscreen, a speaker, and/or the like. In addition, the I/O interface 130 may also include a communication interface for providing the video composited by the video compositing tool 125 to the outside (e.g., an external destination, etc.).

The storage device 140 may be provided as a storage medium of the video compositing system 100. The storage device 140 may store various application programs (e.g., the video compositing tool 125, etc.) executed by the computing device, an OS image, and/or various pieces of data. In some example embodiments, the storage device 140 may store at least one video to be provided as at least one background video, but is not limited thereto. The CPU 110 may provide the videos stored in the storage device 140 to the video compositing tool 125, etc. The storage device 140 may be provided as a memory card (e.g., multi media card (MMC), embedded MMC (eMMC), secure digital (SD), MicroSD) and/or a hard disk drive (HDD), etc. The storage device 170 may include NAND-type flash memory having a large-capacity storage capability. Additionally, and/or alternatively, the storage device 140 may also include next-generation non-volatile memory and/or flash memory, such as PRAM, MRAM, ReRAM, FRAM, and/or the like.

The system bus 150 may be provided as an interconnector for providing a network inside the video compositing system 100. The CPU 110, the working memory 120, the I/O interface 130, and/or the storage device 140, etc., may be electrically connected to each other and may exchange data mutually via the system bus 150. However, the configuration of the system bus 150 is not limited to the above description, and may further include intervention units for efficient management, etc.

The video compositing system 100 according to at least one example embodiment may provide at least one composited video based on real time video, but is not limited thereto. The video compositing system 100 may perform a compositing operation (e.g., combining operation, integrating operation, converting operation, joining operation, etc.) of the real time video in the computing device of the video compositing system 100, thereby providing the composited video to the user of the video compositing system 100 and/or to the outside (e.g., an external destination, etc.) without an additional compositing device for performing the compositing operation. For example, the video compositing system 100 may perform video processing and/or editing within a mobile device at one time without a device of separately editing the background video and/or the user video, thereby providing the composited video easily without additional devices and/or additional work, etc.

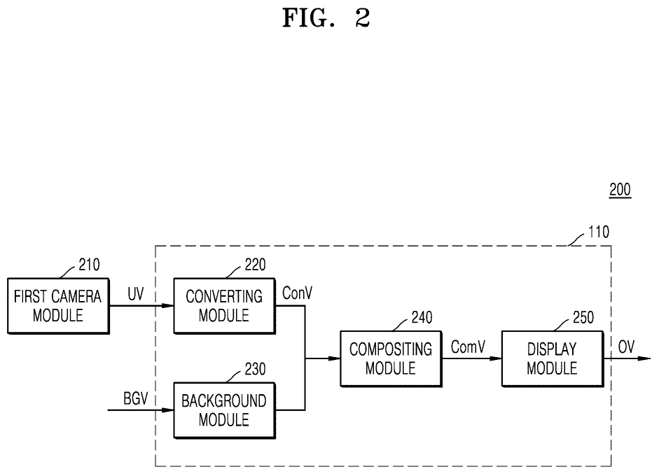

FIG. 2 is a block diagram schematically illustrating a computing device according to at least one example embodiment.

Referring to FIG. 2, a computing device 200 according to at least one example embodiment may include a plurality of modules 210 to 250 for performing a video compositing operation, but the example embodiments are not limited thereto. The computing device 200 may include, e.g., a first camera module 210 (e.g., a first camera, etc.), a converting module 220 (e.g., a converter, a converting device, converter circuitry, etc.), a background module 230 (e.g., background device, background circuitry, etc.), a compositing module 240 (e.g., a compositing device, compositing circuitry, etc.), and/or a display module 250 (e.g., a display device, a display panel, etc.), but the example embodiments are not limited thereto. The computing device 200 may drive, run, and/or execute the plurality of modules 210 to 250, thereby performing at least one video compositing operation. Although not shown, the computing device 200 may further drive various additional modules for compositing videos, etc. The computing device 200 may perform one-way and/or two-way communication (e.g., communication with an external server and/or an external device, etc.) via the Internet and/or a mobile communication network, etc. The computing device 200 may be device with a global positioning system (GPS) module, a sensor module, and/or the like. For example, the computing device 200 may be configured with a smartphone, a personal computer PC, etc. In at least one example embodiment, the computing device 200 may be a wireless communication device, such as a smartphone, a tablet device, a wearable device, a laptop computer, a personal computer, a camera, an action camera, a videorecorder, a personal communication system (PCS), a global system for mobile communications (GSM), personal digital cellular (PDC), a personal handyphone system (PHS), a personal digital assistant (PDA), International mobile telecommunication (IMT)-2000, code division multiple Access (CDMA)-2000, W-CDMA, a wireless broadband Internet (Wibro) terminal, and/or the like.

According to some example embodiments, one or more of the first camera module 210, the converting module 220, the background module 230, the compositing module 240, and/or the display module 250, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The first camera module 210 may capture at least one video (and/or at least one image) to be used in video compositing, thereby outputting the captured video (and/or at least one image, etc.) as a user video UV. For example, the computing device 200 may include a first camera, and the first camera module 210 may obtain at least one video (and/or at least one image, etc.) captured by the first camera of the computing device 200, thereby providing the obtained video to a monitor and/or a display, etc. However, the example embodiments are not limited thereto, and for example, the first camera may be a camera connected to the computing device 200 via a wired connection (e.g., USB cable, etc.) and/or a wireless connection (e.g., Bluetooth, WiFi, etc.). In addition, the first camera module 210 may provide a video and/or one or more images being captured by the camera, e.g., may provide the user video UV to the converting module 220, etc.

In some example embodiments, the converting module 220 may perform a compositing operation (e.g., combining operation, integrating operation, converting operation, joining operation, etc.) by receiving the user video UV. The converting module 220 may select at least one object (and/or at least one region) of the user video UV to be composited with the background video, e.g., select a target object from the user video UV to be combined with the background video, etc. In at least one example embodiment, the converting module 220 may detect a boundary associated with the target object from the user video UV, thereby detecting a specific region to be used in compositing as a target object, etc. The converting module 220 may detect and group the boundary between pixels to classify the boundary into a plurality of objects, and may determine which object(s) of the plurality of objects will be selected as a target object(s). For example, the converting module 220 may detect a user's body part and select the detected body part as a target object using image object detection techniques, such as performing a comparison of pixel color values of each of the pixels of at least one frame of the user video (and/or each of the pixels of a still image, etc.) and comparing the pixel color values with pixel color values of neighboring pixels to detect a difference between the pixel color values exceeding a desired color threshold value, which may be an indication of a boundary between objects in the user video and/or image, but the example embodiments are not limited thereto. As another example, the converting module 220 may identify one or more objects in one or more image frames of the user video UV (and/or still image) using a trained machine learning algorithm and/or trained artificial intelligence, wherein the trained machine learning algorithm and/or trained artificial intelligence may be trained to detect objects based on a similarity of a shape, size, color, and/or motion, etc., of a potential object in the one or more image frames of the user video UV (and/or still image) to objects classified in a video and/or image training data set, etc., but the example embodiments are not limited thereto.

In at least one example embodiment, the converting module 220 may select the target object(s) based on external control, external input, and/or external instructions, etc., but is not limited thereto. For example, the user may watch the user video UV provided from the first camera module 210 through a monitor, a display, etc., and may select which region will be used as a target object in a composited video, etc. In at least one example embodiment, the converting module 220 may provide the plurality of objects detected in the user video UV to the user, and the user may select which object of the plurality of objects will be a target object using a touch input on a touch screen, using a mouse and/or keyboard input(s), using voice commands, etc., but the example embodiments are not limited thereto. Additionally, and/or alternatively, the user may designate a specific region of the user video UV as the target object regardless of the objects classified by the converting module 220, the converting module 220 may automatically detect objects and designate the detected objects, etc., for example, by using a trained machine learning algorithm and/or a trained artificial intelligence, etc.

After selecting the target object, the converting module 220 may process the pixels excluding the target object from the user video UV not to be displayed (e.g., to be excluded, to be omitted, etc.) in the composited video, and may generate a converted video ConV. In an example, the converting module 220 may convert the pixels excluding the target object among the pixels of the user video UV using a Chroma key method, but the example embodiments are not limited thereto. In another example, the converting module 220 may convert the pixels by adjusting alpha values of the pixels of the user video UV, but is not limited thereto. For example, the converting module 220 may adjust alpha values of the pixels excluding the target object among the pixels of the user video UV as 0 to be a transparent pixel. In this way, the converting module 220 may generate a converted video ConV in which a region excluding the target object of the user video UV is transparently processed, and may provide the generated converted video ConV to the compositing module 240, etc. In other words, the converting module 220 may adjust the transparency levels of the pixels of regions of the user video UV which do not include the selected target object, etc., but is not limited thereto.

The background module 230 may receive a background video BGV and may provide the background video BGV to the compositing module 240, etc. That is, the background module 230 may receive the background video BGV with which the target object will be composited (e.g., combined, integrated, etc.), and may properly process the background video BGV so that the background video BGV may be used in the compositing module 240, for example, the background module 230 may adjust the video and/or image resolution and/or size of the background video BGV based on the video and/or image resolution of the user video UV, may adjust the frame rate of the background video BGV based on the frame rate of the user video UV, may adjust the compression rate of the background video BGV based on the frame rate of the user video UV, and/or other settings of the background video BGV based on the equivalent settings of the user video UV. However, the example embodiments are not limited thereto, and for example, the background module 230 may adjust one or more settings of the user video UV based on the equivalent settings of the background video BGV, etc. In some example embodiments, specifically, the background video BGV to be received by the background module 230 may be variously implemented, as will be described below. For example, the background module 230 may receive and process a real time video that is progressing, being recorded, streaming, and/or playing in real time (and/or near real time) from the outside (e.g., an external source, etc.), and may provide the received and processed real time video to the compositing module 240, but the example embodiments are not limited thereto.

The compositing module 240 may composite the converted video ConV provided from the converting module 220 with the background video BGV provided from the background module 230, thereby generating the composited video ConV. In some example embodiments, the compositing module 240 may composite the background video BGV and the converted video ConV with each other by mixing and/or masking, etc. However, the example embodiments are not limited thereto, and a method of compositing the videos using the compositing module 240 may be variously implemented. In an example, the compositing module 240 may composite the videos based on a branding method using a mixing filter, etc. Also, the compositing module 240 may synchronize and match the frames of the converted video ConV including the target object with the frames of the background video BGV, thereby performing a compositing operation in real time (and/or near real time), but the example embodiments are not limited thereto, and for example, the compositing operation may be performed on a pre-recorded background video BGV (e.g., a non-real time background video), etc. In some example embodiments, the background video BGV may be a real time video progressing (e.g., recording, playing, streaming, created, etc.) in real time, but is not limited thereto. In this case, the converting module 220 may select a target object from the user video UV in real time (and/or near real time) to generate a converted video ConV, and the compositing module 240 may generate a composited video ComV based on such real time videos, etc. The compositing module 240 may provide the generated composited video ComV to the display module 250, and the display module 250 may receive the composited video ComV to output an output video OV that is processed so that the composited video ComV may be displayed.

That is, the computing device 200 according to at least one example embodiment may receive real time videos and composite the real time videos with the user video within the computing device 200, but is not limited thereto. As described above, the computing device 200 may generate a composited video based on a background video that is progressing (e.g., recording, playing, streaming, created, etc.) in real time (and/or near real time) without an additional compositing device and/or an editing device (e.g., Chroma key equipment, etc.). In at least one example embodiment, the computing device 200 may be implemented as a mobile terminal that may be easily moved and carried, and the user may use only the mobile terminal without using any external editing devices, etc., thereby receiving a video obtained by compositing the real time video (and/or near real time video) with the user video more conveniently and/or more efficiently, and may be capable of quickly and/or efficiently uploading and/or sharing the composited real time video to an external website, social media service, app, and/or sent directly to another person's computing device, etc.

Also, the computing device 200 according to at least one example embodiment may select the background video to be used for composition using a background module, but is not limited thereto, thereby compositing the background video within the computing device 200 in response to various scenarios desired by the user to provide a composited video to the user.

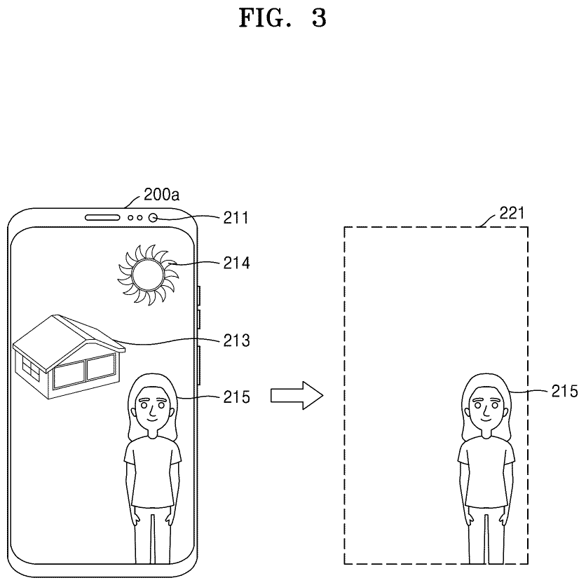

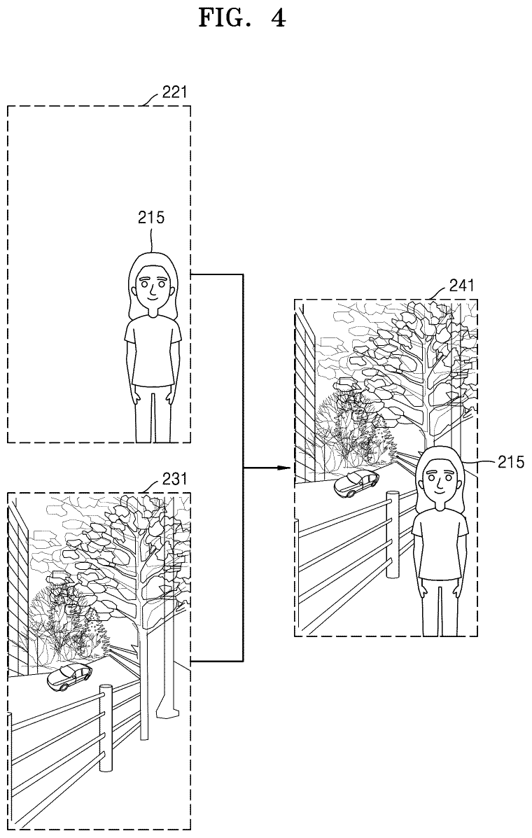

FIG. 3 is a diagram illustrating an object selecting process according to at least one example embodiment. FIG. 4 is a diagram illustrating video compositing according to at least one example embodiment.

Referring to FIGS. 2 and 3, the converting module 220 may select a target object from the user video UV. In at least one example embodiment, the computing device 200 may be implemented with the mobile computing device 200a, as shown. Hereinafter, for the sake of clarity and brevity, the computing device 200 will be described based on the mobile computing device 200a. However, as described above, the computing device 200 may be implemented with various devices in addition to a mobile computing device.

In some example embodiments, the mobile computing device 200a may include a first camera 211. The user video 212 (e.g., UV of FIG. 2) may be a video (and/or image, etc.) captured through the first camera 211, and the captured video may (e.g., the user video 212) may be displayed on a monitor and/or display of the mobile computing device 200a, etc. The first camera module 210 may provide the user video 212 captured through the first camera 211 to the conversion module 220. The converting module 220 may select the target object to be composited with the background video BGV, from the user video 212. In some example embodiments, the converting module 220 may detect the boundary between pixels from the user video 212, thereby selecting (e.g., detecting, identifying, etc.) the target object based on pixel color values of the user video 212 by identifying regions where the differences in the pixel color values are greater than a desired color threshold value, thereby identifying color incongruences in the user video 212 typical of boundaries between different objects, but the example embodiments are not limited thereto, and the converting module 220 may identify boundaries between objects via other techniques. First, the converting module 220 may detect and group the boundary between the pixels, thereby identifying, e.g., a first object 213, a second object 214, and/or a third object 215, etc., from the captured user video 212. In at least one example embodiment, the converting module 220 may detect the third object 215 corresponding to the body part of the objects and may select the detected third object 215 as a target object. In at least one example embodiment, the user may designate a specific region as the selected target object. For example, the user may select the third object 215 as a target object, and the converting module 220 may generate a converted video 221 (e.g., ConV of FIG. 2) based on the selected third object 215 as the target object. The converting module 220 may process a region excluding the third object 215 as the target object from the user video 212 and/or adjust alpha values of the regions around the third object 215 in the user video 212 (e.g., increasing the transparency levels of the regions to be omitted from the user video 212, etc.), thereby generating the converted video 221. Thus, only the third object 215 may be included in the converted video 221, and the converting module 220 may transmit the converted video 221 to the compositing module 240.

Referring to FIGS. 2 and 4, the compositing module 240 may composite the converted video 221 with a background video 231 (e.g., BGV of FIG. 2). The converted video 221 may be a video in which pixels excluding the third object 215 are transparently processed (e.g., the alpha values of the pixels associated with the excluded regions (e.g., the areas of the user video besides the pixels associated with the third object 215) are made to be transparent), but the example embodiments are not limited thereto. The compositing module 240 may composite (e.g., combine, add, integrate, etc.) the converted video 212 with the background video 231, thereby generating the composited video 241. That is, as shown, the compositing module 240 may generate the composited video 241 in which only the third object 215 as the target object is displayed on the background video 231.

In this way, the computing device 200 (and/or the mobile computing device 200a, etc.) according to at least one example embodiment may convert the user video without an additional device, and the user may receive a video in which the converted video and the background video progressing (e.g., recording, playing, streaming, created, etc.) in real time are composited with each other, more conveniently and/or more efficiently, etc.

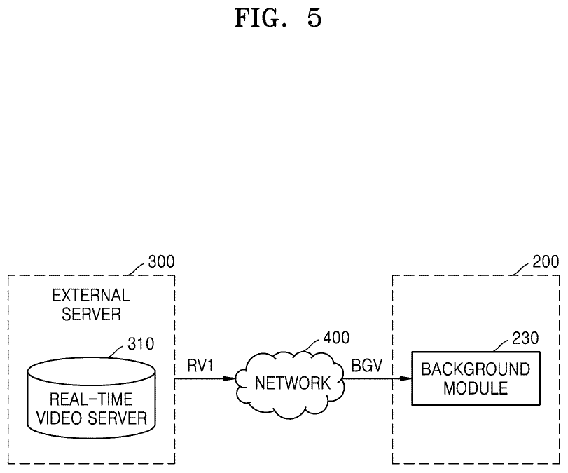

FIG. 5 is a diagram illustrating receiving of a background video according to at least one example embodiment.

Referring to FIGS. 2 and 5, a background module 230 may receive various types of background videos BGV. In some example embodiments, the background module 230 may receive a real time video from at least one first external server 300 through at least one network 400, but the example embodiments are not limited thereto, and for example, the video may be a pre-recorded video, etc. The first external server 300 may include a real time video server 310, but is not limited thereto. In at least one example embodiment, the real time video server 310 may be a server (e.g., a content providing server, etc.) that stores and/or transmits and/or receives a real time captured video (e.g., a first real time video RV1), but is not limited thereto. In at least one example embodiment, the first real time video RV1 may include a game video and/or content video that is progressing (e.g., being recorded, being streamed, being created, being played, etc.) in real time, but the example embodiments are not limited thereto. The real time video server 310 may provide the first real time video RV1 to the background module 230 of the computing device 200 through the network 400. For example, the network 400 may be implemented with one or more types of wireless networks and/or wired networks, such as a local area network (LAN), a wide area network (WAN), a value added network (VAN), a mobile radio communication network, satellite communication network, Bluetooth, wireless broadband Internet (Wibro), high speed downlink packet access (HSDPA), and the like.

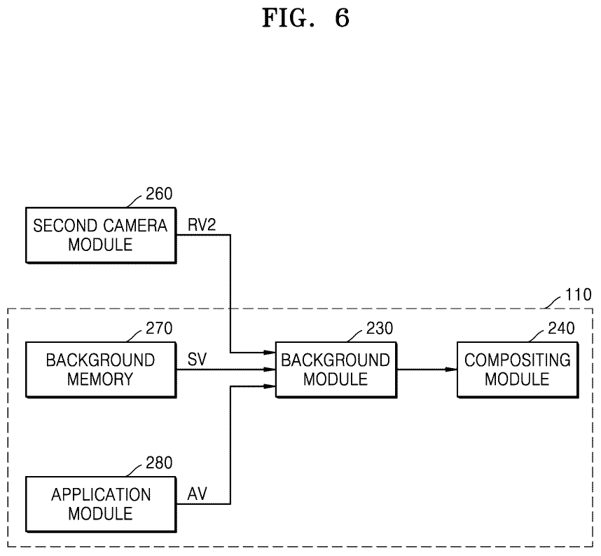

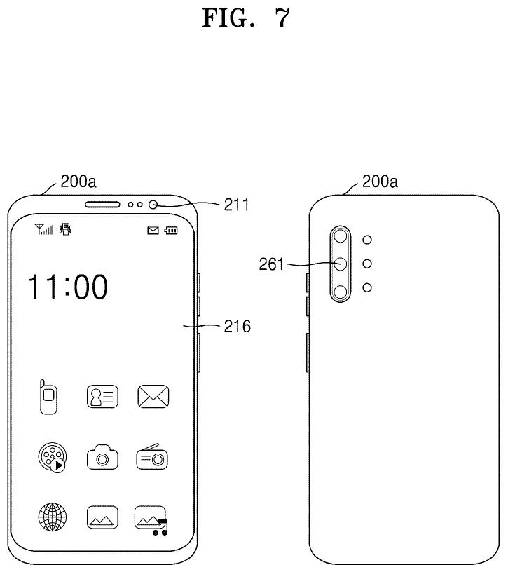

FIG. 6 is a block diagram illustrating a variety of background videos according to at least one example embodiment. FIG. 7 is a diagram illustrating a background video according to at least one example embodiment.

Referring to FIGS. 6 and 7, the computing device 200 (e.g., a mobile computing device 200a, etc.) may include at least one second camera module 260 and at least one second camera 261 (e.g., at least one rear camera, etc.), but the example embodiments are not limited thereto, and for example, the second camera 261 may be a camera connected to the computing device 200 via a wired connection (e.g., USB cable, etc.) and/or a wireless connection (e.g., Bluetooth, WiFi, etc.). A video and/or still image captured by the second camera 261 may be provided to the second camera module 260. For example, the video and/or image captured by the second camera 261 may be provided in real time, and/or near real time, as a second real time video RV2 to the background module 230 using the second camera module 260. The background module 230 may receive the second real time video RV2 as the background video BGV to transmit the second real time video RV2 to the compositing module 240, but is not limited thereto. In other words, the mobile computing device 200a may use a video captured by the first camera 211 as the user video UV and may composite two videos by using the video captured by the second camera 261 as the background video BGV. In this way, the computing device 200 according to at least one example embodiment may generate a composited video ComV by utilizing videos captured by one device as the background video BGV and the user video UV, but the example embodiments are not limited thereto, and for example, a plurality of user videos UV and/or a plurality of background videos BGV may be composited by the computing device 200, etc.

In some example embodiments, the computing device 200 may further include background memory 270. The background memory 270 may be memory in which previously-captured (e.g., pre-recorded, etc.) videos and/or images are stored. A video SV stored in the background memory 270 may be provided to the background module 230, and the background module 230 may receive the stored video SV as the background video BGV and transmit the stored video SV to the compositing module 240. That is, the computing device 200 may utilize the stored video SV as the background video BGV, and the computing device 200 according to at least one example embodiment may generate a composited video ComV by utilizing the video captured by one device and the stored video.

In some example embodiments, the computing device 200 may further include an application module 280. The application module 280 may be a component for driving an application and/or a program (e.g., computer readable instructions, etc.) to be executed in the computing device 200. For example, the application may be a web browser, a social media application, a news application, a sports application, a gaming application, a video streaming application, a chat application, a videoconferencing application, etc., but the example embodiments are not limited thereto. The computing device 200 (e.g., a mobile computing device 200a, etc.) may execute one or more desired applications, thereby utilizing at least one video obtained from the one or more applications, e.g., an application video 216 generated in real time as the background video BGV, etc. The application module 280 may receive the real time and/or near-real time application video 216 from the background module 230, and the background module 230 may receive the application video 216 as the background video BGV and transmit the application video 216 to the compositing module 240, but is not limited thereto. That is, the computing device 200 according to at least one example embodiment may generate a composited video ComV by utilizing a video generated in real time by an application executed in a device as a background video, etc.

In this way, the computing device 200 according to at least one example embodiment may select various background videos obtained and/or received from one or more applications to be used in composition based on the background module 230 that provides a background video by utilizing various types of videos. Thus, the computing device 200 according to at least one example embodiment may provide a composited video to the user in response to various scenarios desired by the user.

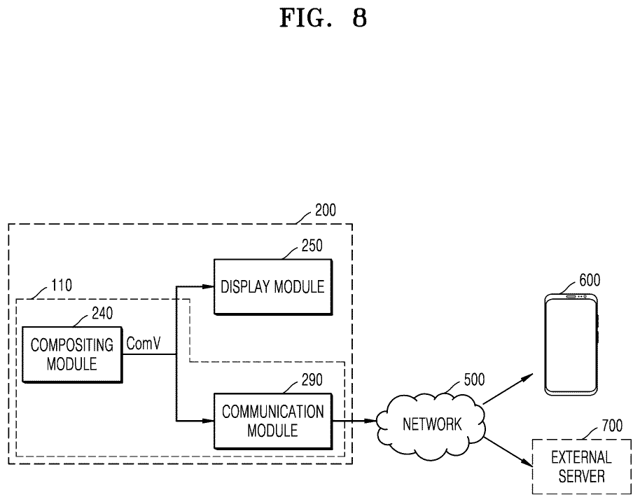

FIG. 8 is a block diagram illustrating a communication process of transmitting a composited video according to at least one example embodiment.

Referring to FIGS. 2 and 8, the computing device 200 may further include a communication module 290 so as to utilize a composited video in various ways. As described above, the compositing module 240 may provide the composited video ComV to the display module 250, thereby outputting the composited video ComV to a display screen. Furthermore, the compositing module 240 may also provide the composited video ComV to the communication module 290. The communication module 290 may provide the composited video ComV to another electronic device 600 and/or an external server 700 via at least one network 500. The communication module 290 may provide communication with a portable terminal, a computer, an external storage medium, and/or a content providing server, etc., and may be implemented with a universal serial bus (USB), infrared ray communication, Bluetooth, WiFi, and/or the like. The communication module 290 may adopt one or more wired and/or wireless communication protocols to provide communication functions, etc. For example, the computing device 200 may transmit the composited video ComV generated according to at least one example embodiment to at least one second portable terminal using the communication module 290, etc. Also, the computing device 200 may provide the composited video ComV to at least one external server 700 using the communication module 290, thereby utilizing the composited video ComV in various ways. According to some example embodiments, the communication module 290 may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

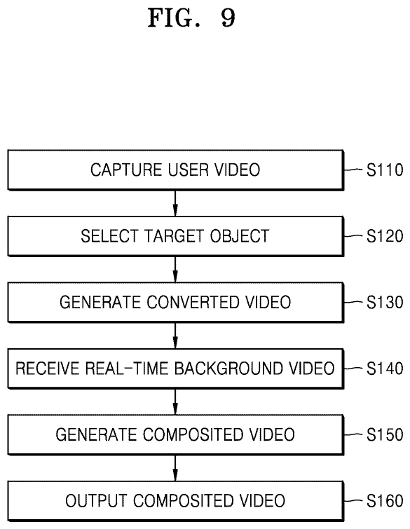

FIG. 9 is a flowchart illustrating a video compositing method according to at least one example embodiment.

Referring to FIG. 9, the video compositing method according to at least one example embodiment may include a plurality of operations S110 to S160, but the example embodiments are not limited thereto, and for example, one or more operations may be omitted, combined, rearranged, etc., and/or additional operations may be added to the method shown in FIG. 9, etc. Hereinafter, FIG. 9 will be described with reference to the previous drawings, and redundant descriptions with descriptions with reference to the previous drawings are omitted.

In operation S110, the first camera module 210 may provide a video captured by a camera as a user video UV to the converting module 220. In at least one example embodiment, the computing device 200 may include a first camera 211 included in and/or connected to the computing device 200, and the first camera module 210 may provide a video captured by the first camera 211 as the user video UV, but the example embodiments are not limited thereto, and for example, the user video UV may be a pre-recorded video and/or a video obtained from a source that is not the first camera 211, etc.

In operation S120, the converting module 220 may receive the user video UV from the first camera module 210, thereby selecting a target object to be composited with the background video BGV. In some example embodiments, the converting module 220 may detect a specific region as a target object from the user video UV. More specifically, the converting module 220 may detect and group the boundary between pixels to classify the boundary into a plurality of objects, and may determine which object of the plurality of objects will be selected as a target object. In at least one example embodiment, the converting module 220 may detect the user's body part, thereby selecting the detected body part as a target object using at least one object detection technique, but the example embodiments are not limited thereto. In at least one example embodiment, the converting module 220 may select the target object based on external control, input, etc. For example, the user may designate a specific region in the user video UV provided from the first camera module 210, and the converting module 220 may select the arbitrary specific region as the target object, etc.

In operation S130, the converting module 220 may generate a converted video ConV based on the selected target object. The converting module 220 may process the pixels of image frames of the user video UV excluding the pixels associated with the target object to generate the converted video ConV. In some example embodiments, the converting module 220 may convert the pixels of the user video UV by excluding the pixels associated with target object among the pixels of the user video UV and converting the remaining pixels using a Chroma key method. Additionally, and/or alternatively, the converting module 220 may adjust alpha values of the remaining pixels of the user video UV, except for the pixels associated with the target object, and set the remaining pixels to be transparent, etc. The converting module 220 may provide the generated converted video ConV to the compositing module 240.

In operation S140, the background module 230 may receive the real time background video BGV and provided the received background video BGV, e.g., a real time background video BGV, etc., to the compositing module 240. The background module 230 may receive the background video BGV with which the target object is to be composited, and may properly process the background video BGV to be used in the compositing module 240, etc., but the example embodiments are not limited thereto. The background module 230 may provide the processed background video BGV to the compositing module 240. In some example embodiments, the background video BGV received by the background module 230 may be variously implemented, as described above with reference to FIGS. 5 and 6, but is not limited thereto. In an example, the background module 230 may receive a real time video that is progressing (e.g., being recorded, being streamed, being created, being played, etc.) in real time from an external source and may provide the received real time video to the compositing module 240, but is not limited thereto.

In operation S150, the compositing module 240 may composite the converted video ConV, received from the converting module 220, with the background video BGV received from the background module 230, thereby generating the composited video ComV. In some example embodiments, the background video BGV may be a real time video that is progressing (e.g., being recorded, being streamed, being created, being played, etc.) in real time, and the converted video ConV may be a video including the target object selected from the user video UV in real time, but is not limited thereto. In this case, the compositing module 240 may composite videos that are provided in real time in this way, thereby generating a composited video ComV, but is not limited thereto.

In operation S160, the composited video ComV generated by the compositing module 240 may be variously output. In some example embodiments, the display module 250 may receive the composited video ComV from the compositing module 240, thereby outputting an output video OV to be displayed on a screen. Also, in some example embodiments, the computing device 200 may further include a communication module 290, and the communication module 290 may receive the composited video ComV from the compositing module 240 and may provide the composited video ComV to another electronic device 600 (e.g., an external storage medium, another computing device, etc.) and/or an external server 700 (e.g., a content providing server, etc.) via at least one network 500.

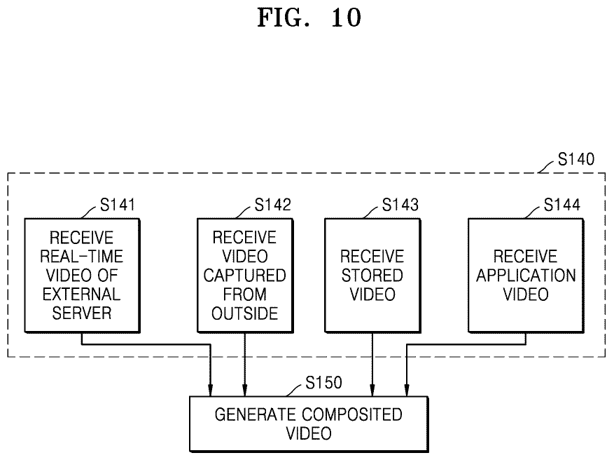

FIG. 10 is a flowchart illustrating a process of receiving a background video according to at least one example embodiment.

Referring to FIGS. 9 and 10, in operation S130, a background video BGV received by the background module 230 may be implemented in various ways. Hereinafter, FIG. 10 will be described with reference to the previous drawings, and redundant descriptions with descriptions with reference to the previous drawings are omitted.

In operation S141, the background module 230 may receive a first real time video RV1 as a first real time video RV1 from a first external server 300, but is not limited thereto. In some example embodiments, the first external server 300 may include a real time video server 310, and the real time video server 310 may be a server (e.g., a content providing server, etc.) that stores and/or transmits and/or receives a video captured in real time, but is not limited thereto. In at least one example embodiment, the first real time video RV1 may include a game video and/or content video that is progressing (e.g., being recorded, being streamed, being created, being played, etc.) in real time, etc.

In operation S142, the background module 230 may receive a real time external video captured by the computing device 200 as a background video BGV. In some example embodiments, the computing device 200 may further include a second camera 261 (e.g., a rear camera, etc.) and a second camera module 260, but the example embodiments are not limited thereto. The background module 230 may receive the second real time video RV2 captured in real time using the second camera 261 as a background video BGV from the second camera module 260, etc.

In operation S143, the background module 230 may receive a previously-stored video SV as the background video BGV. In some example embodiments, the computing device 200 may further include background memory 270, and the background memory 270 may be memory for storing previously-captured videos. That is, the background module 230 may utilize the video SV stored in the background memory 270 of the computing device 200 as the background video BGV.

In operation S144, the background module 230 may receive an application video 216 generated by and/or received from at least one application, as the background video BGV. In some example embodiments, the computing device 200 may further include an application module 280, and the application module 280 may drive various applications to be executed by the computing device 200 from which the application video 216 is received and/or obtained, etc. The application module 280 may provide the application video 216 that is generated in real time and displayed on a monitor etc., to the background module 230, but the example embodiments are not limited thereto. That is, the background module 230 may utilize a real time video generated by various applications executed within the computing device 200 as the background video BGV, etc.

In operation S150, the compositing module 240 may generate a composited video based on various background videos BGV received in operations S141 to S144. The compositing module 240 may composite a converted video ConV received from the converting module 220 and various background videos BGV in operations S141 to S144 with each other, thereby generating a composited video ComV, but is not limited thereto.

That is, the computing device 200 according to at least one example embodiment may select the background video BGV to be used in composition in various ways by utilizing various types of videos, thereby providing a composited video in response to various scenarios desired by the user, etc.

As described above, various example embodiments have been disclosed in drawings and specifications. However, the example embodiments are not limited to the example embodiments described above and it will be understood by one of ordinary skill in the art that a variety of modifications and alterations are possible therefrom. Therefore, the true technical protection scope of this disclosure should be determined by the inventive concepts of the attached claims.

While various example embodiments of the inventive concepts has been particularly shown and described with reference to the figures, it will be understood that various changes in form and details may be made therein without departing from the spirit and scope of the following claims.

What is claimed is:

1. A computing device for compositing videos, the computing device comprising:
a first camera configured to capture a user video; and
processing circuitry configured to,
receive a background video, the receiving the background video including receiving the background video in real time;
select a target object from the user video;
generate a converted video based on the target object and the user video;
generate a composited video based on the background video and the converted video; and
output the composited video to a display device.

2. The computing device of claim 1, wherein
the background video is a real time video received in real time; and
the processing circuitry is further configured to,
convert the user video in real time; and
generate the composited video based on the real time background video and the real time converted video.

3. The computing device of claim 1, wherein the background video is a real time video transmitted by an external server.

4. The computing device of claim 1, further comprising:
a second camera configured to capture the background video in real time.

5. The computing device of claim 1, further comprising:
memory configured to store the background video.

6. The computing device of claim 1, wherein the processing circuitry is further configured to:
execute at least one application, wherein the background video is a video obtained from the at least one application.

7. The computing device of claim 1, wherein the processing circuitry is further configured to generate the converted video by:
converting, using a Chroma key method, at least one pixel other than a pixel corresponding to the target object of the user video.

8. The computing device of claim 1, wherein the processing circuitry is further configured to generate the converted video by:
adjusting alpha values of at least one pixel other than a pixel corresponding to the target object of the user video.

9. The computing device of claim 1, wherein the processing circuitry is further configured to:
transmit the composited video to an external device or an external server.

10. The computing device of claim 1, wherein the processing circuitry is further configured to:
select an object included in the user video as the target object, the object selected via a user input.

11. A video compositing method comprising:
capturing a user video using a first camera;
receiving a real time background video;
selecting a target object from the user video;
generating a converted video based on the target object and the user video;
generating a composited video in real time based on the received background video and the converted video; and
outputting the composited video to a display device.

12. The video compositing method of claim 11, wherein the receiving of the background video comprises:
receiving a real time video transmitted from an external server.

13. The video compositing method of claim 11, wherein the receiving of the background video comprises:
receiving a video obtained using a second camera.

14. The video compositing method of claim 11, wherein the receiving of the background video comprises:
receiving a previously-recorded video.

15. The video compositing method of claim 11, wherein the receiving of the background video comprises:
receiving a video obtained using an application.

16. The video compositing method of claim 11, wherein the selecting of the target object comprises:
selecting an object included in the user video as the target object, the object selected via a user input.

17. The video compositing method of claim 11, wherein the generating of the converted video comprises:
converting, using a Chroma key method, at least one pixel other than a pixel corresponding to the target object of the user video.

18. The video compositing method of claim 11, wherein the generating of the converted video comprises:
adjusting alpha values of at least one pixel other than a pixel corresponding to the target object of the user video.

19. A video compositing system comprising:
processing circuitry; and
memory connected to the processing circuitry and configured to store computer readable instructions,
wherein the processing circuitry, by executing the computer readable instructions, is caused to,
capture a user video using a first camera,
receive a real time background video,
select a target object from the user video,
generate a converted video based on the target object and the user video, and
generate a composited video in real time based on the background video and the converted video.

20. The video compositing system of claim 19, wherein the processing circuitry is further caused to:
receive at least one of a real time video transmitted from an external server, a video captured using a second camera, a video previously stored in the memory, a video obtained from an application, or any combinations thereof; and
adjust alpha values of at least one pixel other than a pixel corresponding to the target object of the user video.
